(19) United States
(12) Patent Application Publication
(10) Pub. No.: US 2024/0405344 A1
(43) Pub. Date: Dec. 5, 2024

(54) BATTERY FOR CLEANER AND CLEANER

(71) Applicant: LG ELECTRONICS INC., Seoul (KR)

(72) Inventors: Junhyung LIM, Seoul (KR); Kietak HYUN, Seoul (KR); Hanshin KIM, Seoul (KR); Jaehun HAN, Seoul (KR); Inkyu HWANG, Seoul (KR)

(73) Assignee: LG ELECTRONICS INC., Seoul (KR)

(21) Appl. No.: 18/679,209

(22) Filed: May 30, 2024

(30) Foreign Application Priority Data
May 31, 2023 (KR) 10-2023-0069905
Mar. 13, 2024 (KR) 10-2024-0034911

(51) Int. Cl. H01M 50/284; A47L 9/28; H01M 50/213; H01M 50/247; H01M 50/262; H01M 50/271; H01M 50/289; H01R 12/72

(52) U.S. Cl. CPC H01M 50/284; A47L 9/2884; H01M 50/213; H01M 50/247; H01M 50/262; H01M 50/271; H01M 50/289; H01M 2220/30; H01R 12/722

(57) ABSTRACT

The present disclosure relates to a cleaner including a battery, in which a battery includes a protruding portion protruding from a battery body to one side, and a button disposed on the protruding portion and configured to selectively fix the battery body to a battery accommodation portion, in which the button is easily operated to separate a handle, and the button does not protrude outward, such that the battery may be compactly configured.

### CROSS-REFERENCE TO RELATED APPLICATION

The present application claims priority to Korean Patent Application Nos. 10-2024-0034911 and 10-2023-0069905, filed on Mar. 13, 2024 and May 31, 2023, the entire contents of which are incorporated herein for all purposes by this reference.

### BACKGROUND OF THE DISCLOSURE

### Field of the Disclosure

The present disclosure relates to a battery for a cleaner and a cleaner, and more particularly, to a battery for a cleaner and a cleaner, in which a battery and a main body are easily assembled.

### Description of the Related Art

In general, a cleaner refers to an electrical appliance that draws in small garbage or dust by sucking air using electricity and fills a dust bin provided in a product with the garbage or dust. Such a cleaner is generally called a vacuum cleaner.

The cleaners may be classified into a manual cleaner which is moved directly by a user to perform a cleaning operation, and an automatic cleaner which performs a cleaning operation while autonomously traveling. Depending on the shape of the cleaner, the manual cleaners may be classified into a canister cleaner, an upright cleaner, a handy cleaner, a stick cleaner, and the like.

The canister cleaners were widely used in the past as household cleaners. However, recently, there is an increasing tendency to use the handy cleaner and the stick cleaner in which a dust bin and a cleaner main body are integrally provided to improve convenience of use.

In the case of the canister cleaner, a main body and a suction port are connected by a rubber hose or pipe, and in some instances, the canister cleaner may be used in a state in which a brush is fitted into the suction port.

The handy cleaner (hand vacuum cleaner) has maximized portability and is light in weight. However, because the handy cleaner has a short length, there may be a limitation to a cleaning region. Therefore, the handy cleaner is used to clean a local place such as a desk, a sofa, or an interior of a vehicle.

A user may use the stick cleaner while standing and thus may perform a cleaning operation without bending his/her waist. Therefore, the stick cleaner is advantageous for the user to clean a wide region while moving in the region. The handy cleaner may be used to clean a narrow space, whereas the stick cleaner may be used to clean a wide space and also used to a high place that the user's hand cannot reach. Recently, modularized stick cleaners are provided, such that types of cleaners are actively changed and used to clean various places.

Meanwhile, depending on cleaning methods, the cleaners may be classified into a wet cleaning type cleaner and a dry cleaning type cleaner. The wet cleaning type cleaner cleans a cleaning region while spraying water or steam or cleans a cleaning region by using a wet mop rag. The dry cleaning type cleaner cleans a cleaning region by sucking dust or scrubs a cleaning region with a brush.

Meanwhile, among wet mop rags, there is a wet mop rag provided with a steam generation device configured to generate steam. The steam generation device includes a tank configured to store water therein and generates steam by vaporizing the water stored in the tank. The steam wet mop rag supplies the generated steam to the mop rag to disinfect the mop rag with steam and sterilize bacteria and the like, which are present on the floor, with high-temperature steam.

Korean Patent Application Laid-Open No. KR10-2021-0024148A discloses a cleaner in which a button is disposed at a rear center of a battery, such that a user may push the button to separate the battery from a battery accommodation portion.

However, in the case of the above-mentioned cleaner, because at least a part of the button is moved into the battery when the button is operated by a user, a space in which the button is moved needs to be provided in the battery. In order to reduce an internal space of the battery, the button inevitably protrudes outward. For this reason, there is a problem in that it is difficult to efficiently use the space.

### SUMMARY OF THE DISCLOSURE

The present disclosure is proposed to solve these problems and aims to provide a battery for a cleaner and a cleaner, in which a button is easily operated to separate a handle.

The present disclosure also aims to provide a battery for a cleaner and a cleaner, in which a button does not protrude outward, such that the battery is compactly configured.

The present disclosure also aims to provide a battery for a cleaner and a cleaner, in which the amount of heat generated from a battery or a printed circuit board may be minimized even in a compact space.

The present disclosure also aims to provide a battery for a cleaner and a cleaner, in which constituent components may be easily assembled to one another.

In order to achieve the above-mentioned objects, a battery for a cleaner according to the present disclosure includes: an upper housing; a lower housing coupled to the upper housing and configured to define a space in which a battery cell and a printed circuit board are accommodated; and a connector coupled to the printed circuit board and having a terminal, in which the printed circuit board is formed in an asymmetric plate shape.

Specifically, the printed circuit board includes: a board body; a connector connection portion extending from one end of the board body based on a longitudinal direction and coupled to the connector; and a board extension portion extending from the other end of the board body based on the longitudinal direction.

In this case, a width of the board extension portion may be smaller than a width of the board body.

Specifically, the width of the board extension portion is equal to or smaller than half the width of the board body.

Therefore, air may flow in the housing of the battery.

Meanwhile, a width of the connector connection portion may be equal to or larger than half a width of the board body.

Therefore, it is possible to prevent the circuit mounted on the printed circuit board from being overheated.

Meanwhile, a width of the board body may be equal to or larger than 0.8 times a width between the pair of lateral cover portions. This is because not only the circuit for controlling the battery, but also the circuit for controlling the main body is mounted.

Meanwhile, the upper housing may include: an upper cover portion configured to cover an upper side of the printed circuit board; and a pair of lateral cover portions extending downward from two opposite ends of the upper cover portion, and two opposite ends of the board extension portion based on a width direction may have different shortest distances to the pair of lateral cover portions.

Therefore, it is possible to prevent the inside air from stagnating and to allow the air to thermally circulate.

Meanwhile, the upper cover portion may include: an upper cover surface configured to face at least a part of the board body; and a rear cover surface configured to face at least a part of the board extension portion, and a shortest distance from the board extension portion to the rear cover surface may be longer than a shortest distance from the board body to the upper cover surface.

Therefore, it is possible to define a space in which the air may dissipate heat while flowing when the heat is generated from the battery cell or the printed circuit board.

Meanwhile, the battery for a cleaner according to the present disclosure may further include a cell holder configured to surround at least a part of the battery cell, in which a shortest distance from an upper end of the cell holder to an upper end of the lateral cover portion may be longer than a shortest distance from the upper end of the cell holder to the upper cover surface, and the board body may be disposed between the cell holder and the upper cover surface.

In this case, the upper cover portion may further include coupling guide portions protruding upward from two opposite ends of the upper cover surface based on a leftward/rightward direction and then extending in a direction in which the coupling guide portions face each other, and the lateral cover portions may extend from two opposite ends of the coupling guide portions based on the leftward/rightward direction.

In addition, the upper end of the lateral cover portion may be disposed to be higher than the upper cover surface, and an electrode of the battery cell may be disposed vertically below the lateral cover portion.

That is, a space, in which air flows, may be formed outside two opposite ends and a rear end of the board body, and a height of the space may be larger than an interval between the board body and the upper housing.

Therefore, the heat generated from the printed circuit board or the battery cell may be transferred, together with air, to the two opposite sides or the rear end based on the leftward/rightward direction, thereby preventing the heat from being concentrated.

Meanwhile, a circuit connected to the battery cell and a circuit connected to a cleaner may be mounted together on the printed circuit board.

That is, an inverter circuit configured to control the main body is mounted on the printed circuit board.

Meanwhile, the upper housing may further include a pair of fixing portions configured to fix coupling of the upper housing and the lower housing, and the connector connection portion may be disposed between the pair of fixing portions.

In addition, the lower housing may further include a pair of fixing portions configured to fix coupling of the upper housing and the lower housing, and the connector may be disposed between the pair of fixing portions.

Meanwhile, the lower housing may include a pair of cell holder fixing portions configured to fix the cell holder, and the connector connection portion may be disposed between the pair of cell holder fixing portions when viewed from above the printed circuit board.

In addition, the cell holder fixing portion may be disposed forward of the board body.

Therefore, the work tool may easily approach the cell holder fixing portion during the assembling process.

Meanwhile, the lower housing may include a front cover portion configured to cover a front side of the battery cell holder, and the connector is disposed below the upper housing and disposed forward of the front cover portion.

Therefore, the connector may be easily coupled to the main body, and dust or the like may be prevented from accumulating on the connector.

### BRIEF DESCRIPTION OF THE DRAWINGS

FIG. 1 is a perspective view illustrating a cleaner according to an embodiment of the present disclosure.

FIG. 2 is a view for explaining a state in which a battery is separated from a main body of the cleaner in FIG. 1.

FIG. 3 is a perspective view of the battery for a cleaner according to the embodiment of the present disclosure.

FIGS. 4A and 4B are exploded perspective views of FIG. 3.

FIG. 5 is a front view of FIG. 3.

FIG. 6 is a cross-sectional view of FIG. 3.

FIGS. 7A and 7B are perspective views for explaining an upper housing of the battery for a cleaner according to the embodiment of the present disclosure.

FIG. 8 is a bottom plan view of FIG. 7.

FIG. 9 is a perspective view for explaining a lower housing of the battery for a cleaner according to the embodiment of the present disclosure.

FIG. 10 is a top plan view of FIG. 9.

FIG. 11 is a perspective view for explaining a button part of the battery for a cleaner according to the embodiment of the present disclosure.

FIG. 12 is a perspective view when FIG. 11 is viewed at another angle.

FIG. 13 is a side view of FIG. 12.

FIG. 14 is a top plan view of FIG. 12.

FIG. 15 is a view for explaining a state in which the button part of the battery for a cleaner according to the embodiment of the present disclosure is coupled to the main body of the cleaner.

FIG. 16 is a view for explaining a state in which the button part of the battery for a cleaner according to the embodiment of the present disclosure is uncoupled from the main body of the cleaner.

FIG. 17 is a perspective view for explaining a printed circuit board of the battery for a cleaner according to the embodiment of the present disclosure.

FIG. 18 is a perspective view illustrating a state in which the upper housing of the battery for a cleaner according to the embodiment of the present disclosure is separated.

FIG. 19 is a top plan view of FIG. 18.

FIGS. 20 and 21 are perspective views for explaining a cell holder of the battery for a cleaner according to the embodiment of the present disclosure.

FIG. 22 is a perspective view illustrating a state in which the upper housing and the printed circuit board of the battery for a cleaner according to the embodiment of the present disclosure are separated.

### DETAILED DESCRIPTION OF THE DISCLOSURE

Hereinafter, exemplary embodiments of the present disclosure will be described in detail with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

The terminology used herein is used for the purpose of describing particular embodiments only and is not intended to limit the present disclosure. Singular expressions may include plural expressions unless clearly described as different meanings in the context.

Unless otherwise defined, all terms used herein, including technical or scientific terms, may have the same meaning as commonly understood by those skilled in the art to which the present disclosure pertains. The terms such as those defined in a commonly used dictionary may be interpreted as having meanings consistent with meanings in the context of related technologies and may not be interpreted as ideal or excessively formal meanings unless explicitly defined in the present application.

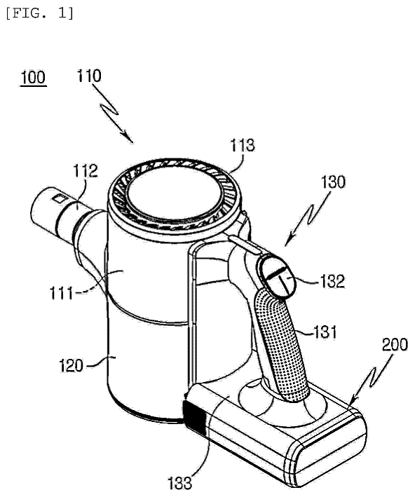

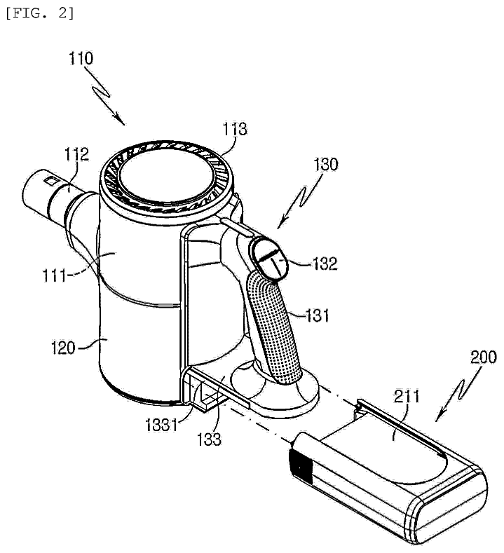

FIG. 1 is a perspective view illustrating a cleaner according to an embodiment of the present disclosure, and FIG. 2 is a view for explaining a state in which a battery is separated from a main body of the cleaner in FIG. 1.

Meanwhile, the term “floor surface” used in the present specification may mean not only a floor surface of a room such as a living room but also a cleaning surface such as a carpet.

Main constituent elements of a cleaner 100 according to the present disclosure will be briefly described below with reference to FIGS. 1 and 2.

The cleaner 100 may mean a cleaner configured to be manually operated by the user. For example, the cleaner 100 may mean a handy cleaner or a stick cleaner.

The cleaner 100 may include a main body 110. The main body 110 is a constituent element that defines an external appearance of the cleaner 100 and serves to suck and discharge air during a cleaning operation.

A structure of the main body 110 of the cleaner will be described below.

The main body 110 includes a main body housing 111, a suction part 112, a dust separating part (not illustrated), a suction motor (not illustrated), and a discharge part 113.

Meanwhile, in the cleaner 100 according to the embodiment of the present disclosure, directions may be defined on the basis of when a bottom surface (lower surface) of a dust bin 120 and/or a bottom surface (lower surface) of a battery 200 are placed on the ground surface.

In this case, a forward direction may mean a direction in which the suction part 112 is disposed based on the main body housing 111, and a rearward direction may mean a direction in which a handle 131 is disposed based on the main body housing 111. Further, based on a state in which the suction part 112 is viewed from the main body housing 111, a rightward direction may refer to a direction in which a component is disposed at the right, and a left direction may refer to a direction in which a component is disposed at the left.

In addition, in the embodiment of the present disclosure, upper and lower sides may be defined in a direction perpendicular to the ground surface based on the state in which the bottom surface (lower surface) of the dust bin 120 and the bottom surface (lower surface) of the battery 200 are placed on the ground surface.

The main body 110 is separably coupled to a cleaning module (not illustrated). Specifically, the main body 110 may be connected directly to the cleaning module (not illustrated) or indirectly connected to the cleaning module (not illustrated) through an extension tube (not illustrated). That is, the suction part 112 is coupled to the cleaning module (not illustrated) or the extension tube (not illustrated).

In case that a suction port is provided in the cleaning module (not illustrated), the suction motor (not illustrated) provides a suction force to the cleaning module (not illustrated).

The main body 110 may be connected to the extension tube (not illustrated). The main body 110 may be connected to the cleaning module (not illustrated) through the extension tube (not illustrated). The main body 110 may generate the suction force by means of the suction motor (not illustrated) and provide the suction force to the cleaning module (not illustrated) through the extension tube (not illustrated). In this case, outside dust may be introduced into the main body 110 through the cleaning module (not illustrated) and the extension tube (not illustrated).

The main body housing 111 defines an external shape of the cleaner 100 and accommodates the main constituent elements therein. At least a part of the dust separating part (not illustrated), the suction motor (not illustrated), and a filter (not illustrated) may be provided in the main body housing 111.

The suction part 112 may be connected to the main body housing 111. The suction part 112 may be provided so that air containing dust is introduced into the main body 110. For example, a flow path (suction flow path), into which air may be introduced, may be formed in the suction part 112.

The suction part 112 may be coupled to the extension tube (not illustrated). Alternatively, the suction part 112 may be coupled directly to the cleaning module (not illustrated).

The discharge part 113 may be disposed at an upper end of the main body housing 111.

The discharge part 113 may be configured to discharge the air, which has passed through the suction motor (not illustrated), to the outside. The discharge part 113 may have a flow path through which the air having passed through the suction motor (not illustrated) is discharged.

The dust separating part (not illustrated) communicates with the extension tube (not illustrated) through the suction flow path. The dust separating part may separate the dust introduced into the dust separating part through the extension tube (not illustrated) and the suction flow path.

The dust separating part may communicate with the dust bin 120. More specifically, at least a part of the dust separating part may be disposed in the dust bin 120. Therefore, the dust separated by the dust separating part is collected in the dust bin 120, and the air is discharged to the outside of the dust separating part.

The dust separating part may be a cyclone part capable of separating dust using a cyclone flow. That is, the dust separating part may include at least one cyclone part. Therefore, air and dust, which are sucked through the extension tube (not illustrated), spirally flow along an inner circumferential surface of the dust separating part. Therefore, the cyclone flow may be generated about a central axis of the dust separating part.

The suction motor (not illustrated) is a constituent element configured to generate a suction force for sucking air.

The suction motor (not illustrated) is accommodated in the main body housing 111. The suction motor (not illustrated) includes an impeller and generates the suction force by rotating the impeller.

The suction motor (not illustrated) may be disposed above the dust bin 120. With this arrangement, a part of the dust in the air sucked into the suction motor (not illustrated) is collected in the dust bin 120 by gravity, which increases a lifespan of the suction motor (not illustrated).

The suction motor (not illustrated) is disposed at a downstream side of the dust bin 120. With this arrangement, the air introduced through the suction part 112 may be filtered in the dust separating part, which is disposed in the dust bin 120, and then introduced into the suction motor (not illustrated).

The filter (not illustrated) is a constituent element configured to filter out foreign substances contained in the flowing air. The filter may include a prefilter or a HEPA filter.

The prefilter is a filter disposed at the most upstream side among the filters. The prefilter is formed in a mesh shape and primarily filters out physically large dust. The prefilter is a constituent element that physically filters out dust larger than intervals between the meshes, thereby improving lifespans of the other filters.

The high-efficiency particulate air (HEPA) filter is a constituent element that filters out fine dust. In general, the HEPA filter filters out fine dust by means of an electrostatic force. The HEPA filter filters out fine dust contained in the dust introduced from the dust bin 120, thereby preventing fine dust from being discharged to the outside of the cleaner 100.

The filters may be disposed at the upstream side and/or the downstream side of the suction motor (not illustrated). The filter may filter out dust in the air to be introduced into the suction motor (not illustrated), thereby protecting the suction motor (not illustrated). Further, the filter may filter the air to be discharged to the outside from the suction motor (not illustrated), thereby preventing dust from scattering to the outside of the cleaner 100.

The cleaner 100 may include the dust bin 120. The dust bin 120 may communicate with the dust separating part (not illustrated). The dust bin 120 may store the dust separated by the dust separating part. For example, the dust bin 120 may be formed in a cylindrical shape and have a space in which dust may be stored. In addition, in a state in which the dust bin 120 is coupled to the main body housing 111, at least a part of the dust separating part (not illustrated) may be disposed in the dust bin 120.

A lower side of the dust bin 120 may have an opening portion and be partially opened. The dust bin 120 includes a discharge cover configured to open or close the opened lower side.

The discharge cover (not illustrated) is a constituent element that covers the opened lower side of the dust bin 120. The dust in the air, which is sucked when the cleaner 100 operates, is collected in the dust bin 120. Further, the dust collected in the dust bin 120 may be discharged to the outside when the discharge cover is opened.

The discharge cover may be disposed at the lower side of the dust bin 120. The discharge cover may selectively open or close the lower side of the dust bin 120 opened downward.

The cleaner 100 includes a handle assembly 130. The handle assembly 130 is a constituent element configured to be gripped by a user.

The handle assembly 130 includes the handle 131 that may be gripped by the user.

The handle 131 may be formed to be gripped. For example, the handle 131 may be formed in a shape similar to a cylindrical shape. Alternatively, the handle 131 may be formed in a curved cylindrical shape.

The handle assembly 130 includes an operating part 132 to which control instructions related to the cleaning module (not illustrated) or the main body 110 are inputted.

The operating part 132 is a constituent element that receives instructions from the user. The operating part 132 may be disposed on an upper portion of the handle 131.

A front end of the operating part 132 may be disposed above a rear end of the operating part 132. With this arrangement, the user may push and manipulate the operating part 132 with the thumb while gripping the handle.

A battery coupling part 133 may be disposed may be disposed at a rear lower side of the main body 110. The battery coupling part 133 may be disposed rearward of the dust bin 120. The battery coupling part 133 may be disposed below the handle 131.

The battery 200 is detachably coupled to the battery coupling part 133. The battery 200 is detachably coupled to the battery coupling part 133 in a sliding manner. Specifically, guide rails 1331 may be formed on the battery coupling part 133 in a forward/rearward direction. The guide rails 1331 may be moved along coupling guide portions 211d formed on the battery 200. The battery 200 may be coupled to the battery coupling part 133 by being moved from the rear side to the front side of the battery coupling part 133. The battery 200 may be separated from the battery coupling part 133 by being moved rearward.

The cleaner 100 includes the extension tube (not illustrated). The extension tube (not illustrated) is a constituent element configured to guide the air, which is sucked from the cleaning module (not illustrated), to the main body 110.

A front end of the extension tube (not illustrated) is coupled to the cleaning module (not illustrated), and a rear end of the extension tube (not illustrated) is selectively coupled to any one of the main body 110 and the handle assembly 130.

One end of the extension tube (not illustrated) communicates with the cleaning module (not illustrated), and the other end of the extension tube (not illustrated) communicates with the main body 110. The extension tube (not illustrated) may communicate with the suction part 112 of the main body 110. The extension tube (not illustrated) is formed in a long cylindrical shape.

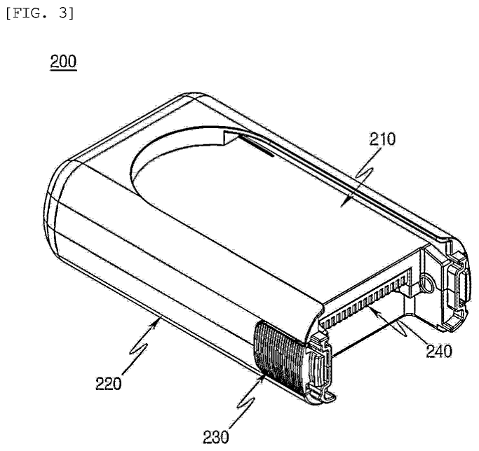

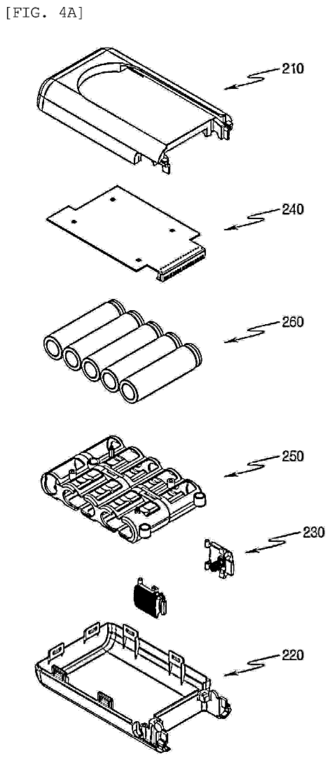

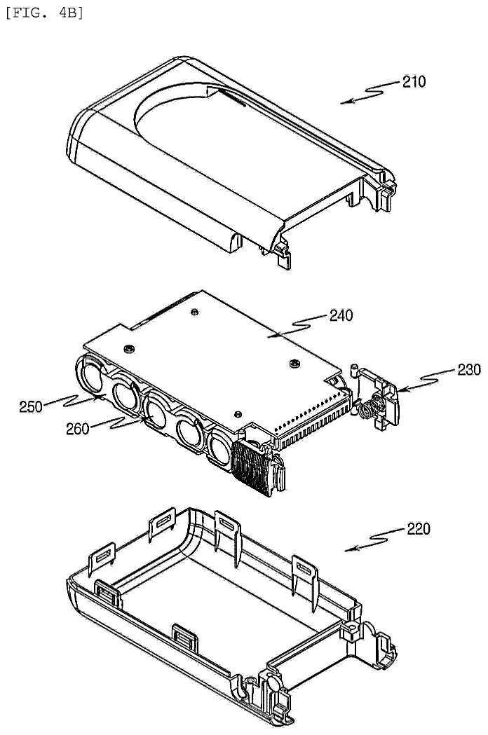

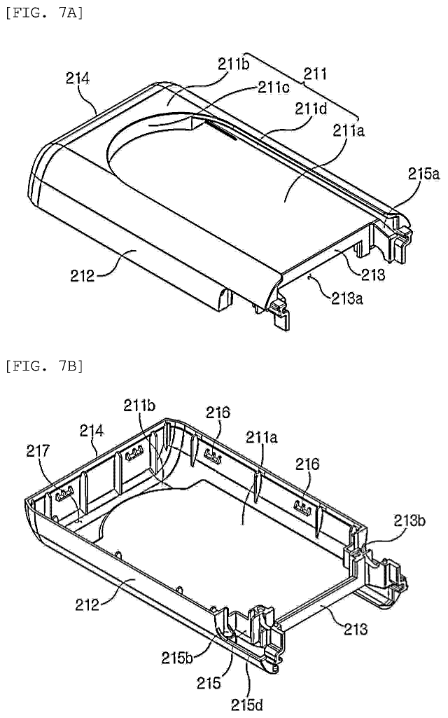

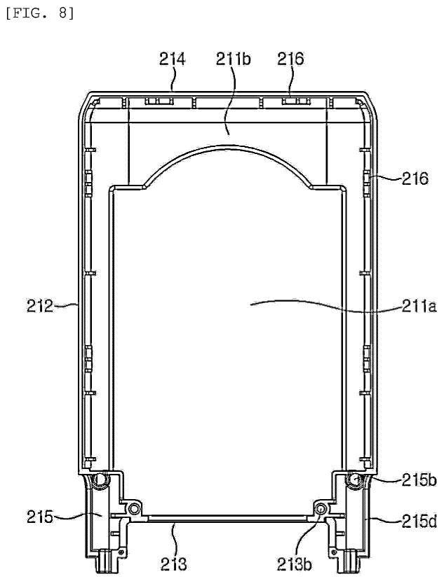

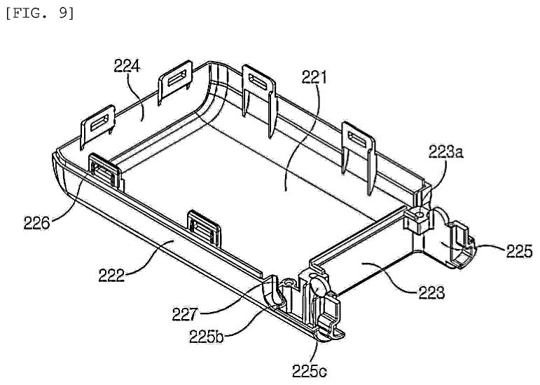

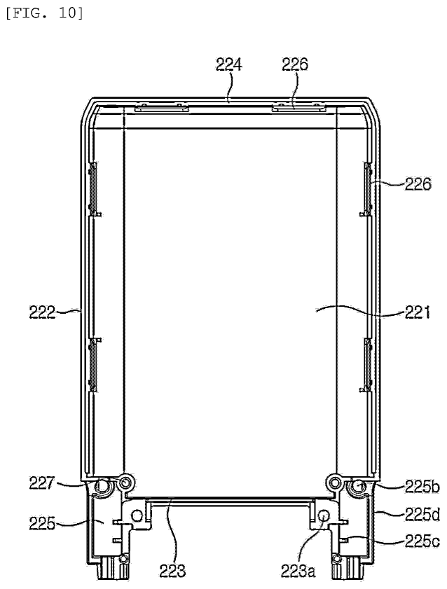

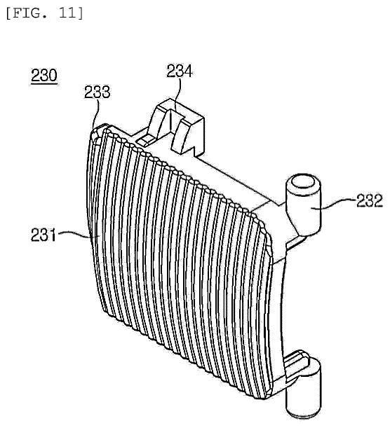

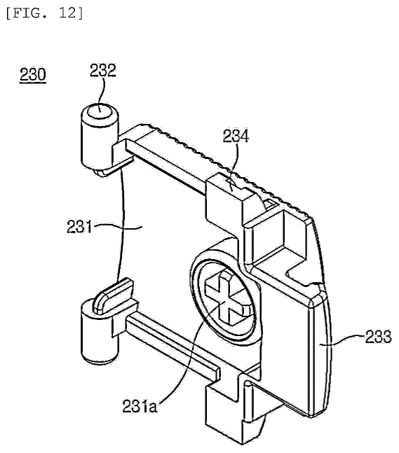

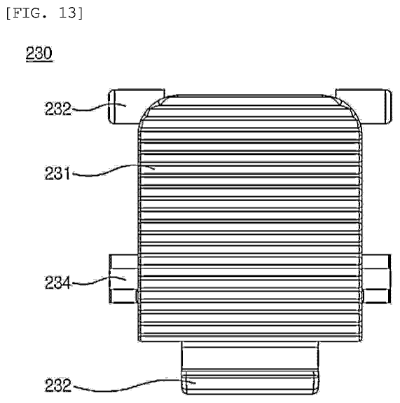

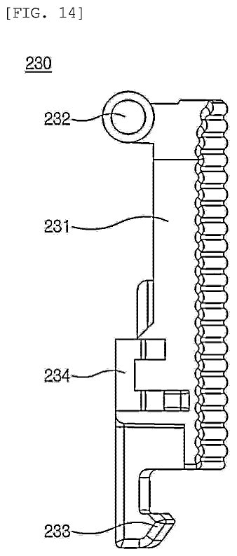

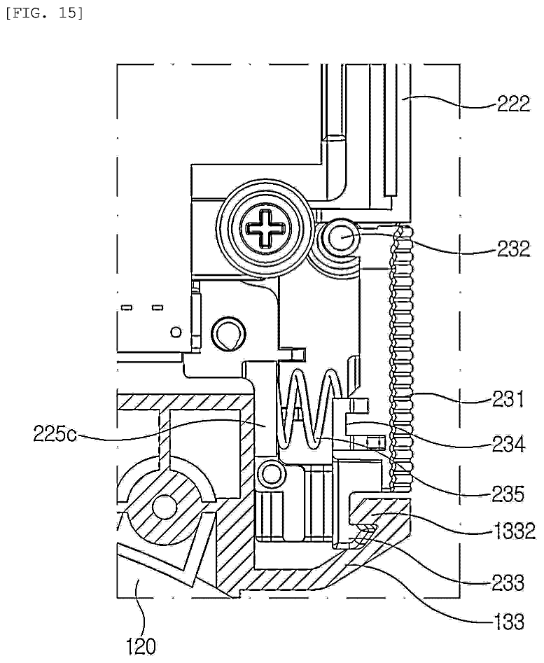

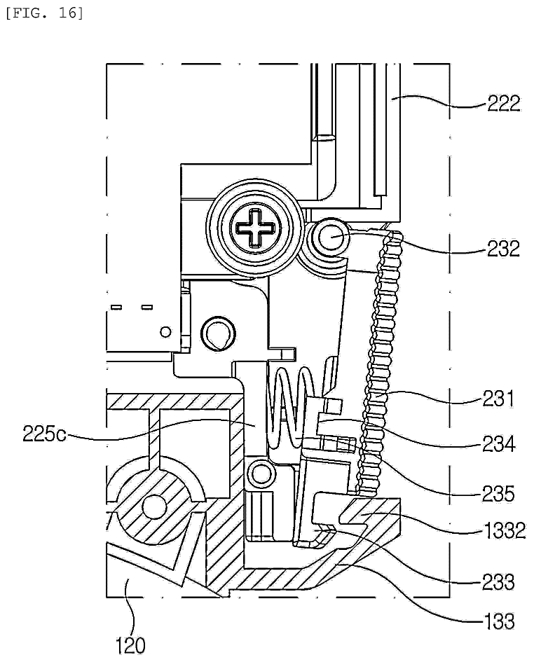

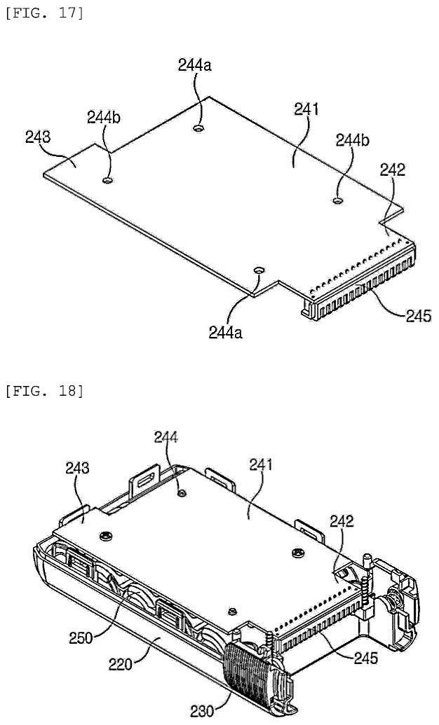

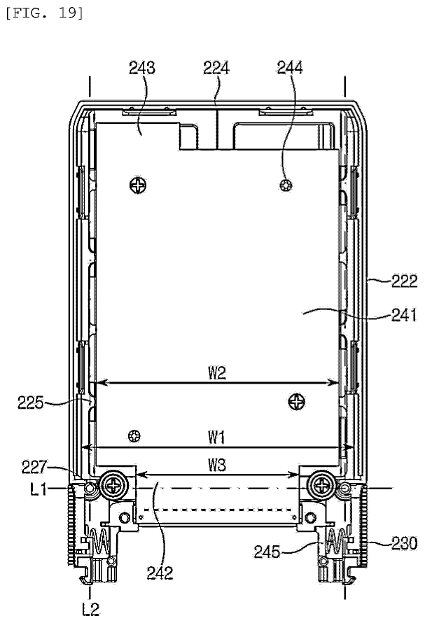

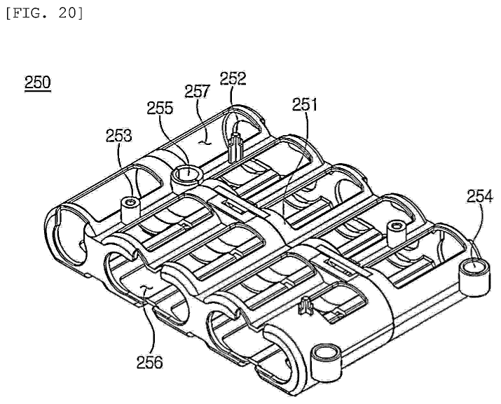

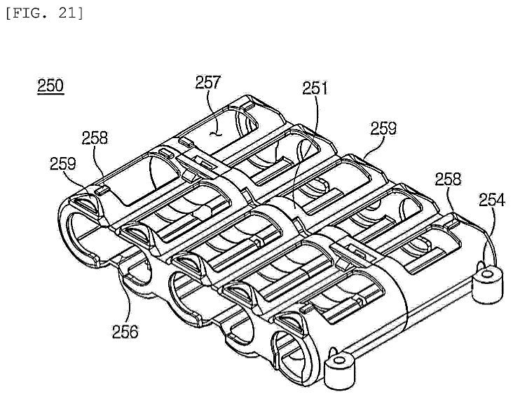

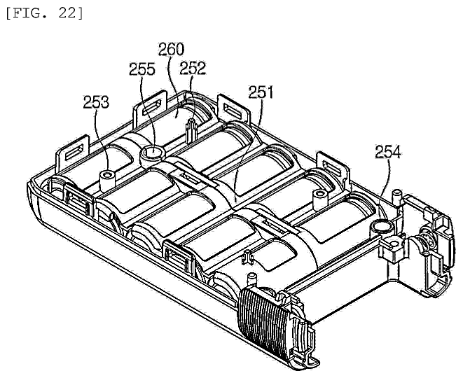

FIGS. 3 to 6 illustrate the battery for a cleaner according to the embodiment of the present disclosure, FIGS. 7A, 7B, and 8 are views for explaining an upper housing, FIGS. 9 and 10 are views for explaining a lower housing, FIGS. 11 to 14 are views for explaining a button part, FIGS. 15 and 16 are views for explaining states in which the button part of the battery for a cleaner according to the embodiment of the present disclosure is coupled to and uncoupled from the main body of the cleaner, FIG. 17 is a perspective view for explaining a printed circuit board of the battery for a cleaner according to the embodiment of the present disclosure, FIGS. 18 and 19 are views illustrating a state in which the upper housing is separated, FIGS. 20 and 21 are views for explaining a cell holder, and FIG. 22 is a perspective view illustrating a state in which the upper housing and the printed circuit board are separated.

The battery for a cleaner according to the embodiment of the present disclosure will be described below with reference to FIGS. 3 to 22.

The battery 200 is a constituent element configured to supply power to the constituent elements of the cleaner 100 including the suction motor (not illustrated).

The battery 200 is separably coupled to the battery coupling part 133 and supplies power to the main body 110.

The battery 200 may be disposed below the handle 131 in the state in which the battery 200 is coupled to the battery coupling part 133. In addition, the battery 200 may be disposed rearward of the dust bin 120.

That is, the suction motor (not illustrated) and the battery 200 may be disposed so as not to overlap each other in the upward/downward direction and disposed at different arrangement heights. Based on the handle 131, the suction motor (not illustrated), which is heavy in weight, is disposed forward of the handle 131, and the battery 200, which is heavy in weight, is disposed below the handle 131, such that an overall weight of the cleaner 100 may be uniformly distributed. Therefore, it is possible to prevent stress from being applied to the user's wrist when the user grips the handle 131 and performs the cleaning operation.

The battery 200 includes an upper housing 210, a lower housing 220, button parts 230, a printed circuit board 240, a cell holder 250, and battery cells 260.

The upper housing 210 and the lower housing 220 define an external shape of the battery 200 and define a space in which other constituent elements may be accommodated.

The upper housing 210 defines an upper external shape of the battery 200 and is coupled to a lower side of the handle 131.

The upper housing 210 may be formed in a shape similar to a box shape opened at a lower side thereof. Specifically, the upper housing 210 may include an upper cover portion 211, a pair of lateral cover portions 212 extending downward from two opposite sides of the upper cover portion 211 based on a major axis direction, a front cover portion 213 extending downward from a front end of the upper cover portion 211, and a rear cover portion 214 extending downward from a rear end of the upper cover portion 211.

The upper cover portion 211 may be formed in a shape corresponding to a shape of the lower side of the handle 131 so that the upper cover portion 211 is coupled to the lower side of the handle 131.

For example, the upper cover portion 211 may include an upper cover surface 211a formed in a flat plate shape, and a rear cover surface 211b formed to have a stepped portion protruding upward from the upper cover surface 211a. In this case, the upper cover surface 211a may be formed in a shape having a constant width in the leftward/rightward direction, and a rear side of the upper cover surface 211a may be formed in a semicircular shape. That is, the upper cover surface 211a may have a shape in which a semicircular surface is connected to a rear side of a rectangular surface. In this case, a width of the upper cover surface 211a in the leftward/rightward direction may be equal to a width of a lower end of the handle 131 in the leftward/rightward direction. Further, the rear cover surface 211b may be formed to have a predetermined height difference from the upper cover surface 211a. The rear cover surface 211b may be formed in a shape made by removing a semicircle from a rectangular plane (see FIG. 7A). Further, the rear end of the upper cover surface 211a and a front end of the rear cover surface 211b may be connected by a stopper wall 211c. That is, the stopper wall 211c may mean a surface extending upward from an outer periphery of a rear side of the upper cover surface 211a and connected to an outer periphery of a front side of the rear cover surface 211b.

With this configuration, the lower end of the handle 131 slides along the upper cover surface 211a and then comes into contact with the stopper wall 211c, such that a movement of the handle 131 may be restricted.

Meanwhile, the upper cover portion 211 further includes the pair of coupling guide portions 211d. The coupling guide portions 211d may protrude upward from the upper cover surface 211a. Specifically, the coupling guide portions 211d may symmetrically protrude from the two opposite sides of the upper cover surface 211a based on the major axis direction. For example, the coupling guide portions 211d may protrude, by a predetermined height, upward from the two opposite ends of the upper cover surface 211a based on the leftward/rightward direction and then extend, by a predetermined length, in a direction in which the coupling guide portions 211d face each other. In this case, a shortest distance between the pair of coupling guide portions 211d is smaller than the width of the lower end of the handle 131 in the leftward/rightward direction. That is, the coupling guide portion 211d may serve as a guide rail. With this configuration, the lower end of the handle 131 may slide along the coupling guide portions 211d, such that the battery 200 may be stably coupled. In addition, the battery 200 is prevented from being withdrawn in the upward/downward direction in the state in which the battery 200 is coupled to the dust bin 120 and the handle assembly 130.

Meanwhile, the coupling guide portions 211d may be formed above button coupling portions 215 to be described below. In this case, a height difference between an upper end of the coupling guide portion 211d and a handle entry surface 215a of the button coupling portion 215 is larger than a height difference between the upper cover surface 211a and an upper end of the coupling guide portion 211d. With this configuration, a space that the lower end of the handle 131 enters is provided to be large, such that the user may easily couple the handle 131 and the battery 200.

Meanwhile, the pair of lateral cover portions 212 may be symmetrically formed. For example, the pair of lateral cover portions 212 may extend downward from the upper cover portion 211 and each be formed in a curved shape having a predetermined curvature. That is, the upper cover portion 211 and the pair of lateral cover portions 212 may be connected in the form of a continuous surface. Specifically, the pair of lateral cover portions 212 may be connected to the pair of coupling guide portions 211d and formed in the form of a continuous surface. With this configuration, in case that an impact is applied to the battery 200, the impact may be prevented from being concentrated at a particular position on the battery 200, thereby improving durability.

Meanwhile, a boundary between the coupling guide portion 211d and the lateral cover portion 212 may be determined on the basis of whether there is a surface facing the handle 131. That is, the coupling guide portion 211d may include a surface facing the handle 131, and a vertically upper portion thereof in the state in which the coupling guide portion 211d is coupled to the handle 131. The lateral cover portion 212 may mean a portion directed toward the outside of the cleaner 100.

The front cover portion 213 may be formed to cover a front side of the upper housing 210. For example, the front cover portion 213 may extend downward from the front end of the upper cover portion 211. The front cover portion 213 may extend downward from a front end of the upper cover surface 211a.

Meanwhile, a height at which the front cover portion 213 is formed in the upward/downward direction is smaller than a height at which the lateral cover portion 212 is formed in the upward/downward direction. That is, a height difference may occur between a lower end of the lateral cover portion 212 and a lower end of the front cover portion 213. Further, a space with a predetermined height may be formed at a front lower side of the upper housing 210 because of the height difference. A connector 245, which connects the printed circuit board 240 and the main body 110, which will be described below, in an electrical and/or signal manner, may be exposed to the outside of the upper housing 210 through the above-mentioned space. Therefore, at least a part of the printed circuit board 240 and/or the connector 245 may pass through the space (hereinafter, referred to as a connector passing hole 213a) and be disposed outside the upper housing 210.

Meanwhile, fixing portions 213b may be formed on the front cover portion 213. The fixing portion 213b may be disposed to protrude rearward from the front cover portion 213, and a groove or hole may be formed in the protruding portion. The fixing portion 213b may fix the coupled state of the upper housing 210 and the lower housing 220 by means of a coupling member such as a screw.

The rear cover portion 214 and formed to cover a rear side of the upper housing 210. For example, the rear cover portion 214 may extend downward from the rear end of the upper cover portion 211. The rear cover portion 214 may extend downward from a rear end of the rear cover surface 211b of the upper cover portion 211. In this case, according to the embodiment, the rear end of the rear cover surface 211b and the rear cover portion 214 may be connected in the form of a continuous surface while defining a curved surface. Therefore, an impact may be prevented from being concentrated at a particular position when an external force is applied.

Meanwhile, the upper housing 210 further includes the button coupling portions 215. The pair of lateral cover portions 212 may extend forward from the button coupling portions 215. In addition, the pair of coupling guide portions 211d may extend forward from the button coupling portions 215. At least a part of the button coupling portion 215 may further protrude forward than the front cover portion 213.

Meanwhile, the button coupling portions 215 may include the entry surfaces 215a extending forward from the two opposite sides of the upper cover surface 211a based on the leftward/rightward direction and inclined downward in the forward direction.

Meanwhile, the connector 245 of the printed circuit board 240 may be disposed in the inner side at which the pair of button coupling portions 215 face each other.

Further, the button parts 230 to be described below may be respectively coupled to the button coupling portions 215. Specifically, the button part 230 may be hingedly coupled to an outer side (opposite to the inner side) of the button coupling portion 215. For example, the button coupling portions 215 may each have a surface facing a bottom of the button part 230, and a hinge groove 215b coupled to be rotatable relative to a hinge protrusion of the button part 230.

Meanwhile, fastening portions 216 configured to be coupled to the lower housing 220 may be provided on the upper housing 210. For example, the fastening portions 216 may protrude from the inner surface of the lateral cover portion 212 and the inner surface of the rear cover portion 214. For example, the fastening portion 216 may protrude in a hook shape.

In this case, the plurality of fastening portions 216 may be formed at predetermined distances. For example, the pair of fastening portions 216 may be formed on each of the pair of lateral cover portions 212, and the pair of fastening portions 216 may be formed on the rear cover portion 214. Therefore, the coupling force may be maintained even though an external force is applied to the front or rear side of the battery 200, and the coupling force may be maintained even though an external force is applied to the left or right side of the battery 200.

With this configuration, when the upper housing 210 and the lower housing 220 are fitted with each other, the fastening portions 216 of the upper housing 210 may be coupled by a hook engagement.

With reference to the overall shape of the upper housing 210, a part of the upper surface of the upper housing 210 may define a groove recessed downward. The lower end of the handle 131 may be inserted into the groove. In addition, guide rails may be formed on two opposite lateral surfaces of the groove and guide the sliding movement of the lower end of the handle 131. With this configuration, the user may easily and stably couple and fix the lower end of the handle 131 by fitting the lower end of the handle 131 with the guide rail and then sliding the lower end of the handle 131.

In addition, the printed circuit board 240 may be accommodated in the upper housing 210. Therefore, the upper housing 210 may accommodate the printed circuit board 240 therein and protect the printed circuit board 240 from an external impact or moisture.

Meanwhile, an internal structure of the upper housing 210 is formed to correspond to an external shape of the upper housing 210. That is, a width of the internal space of the upper housing 210 in the leftward/rightward direction is larger than a width of the upper cover surface 211a. This is because the internal space of the upper housing 210 includes a space of the upper cover surface 211a in the leftward/rightward direction and a space of the lateral cover portion 212 in the leftward/rightward direction.

In addition, a length of the internal space of the upper housing 210 in the forward/rearward direction (a length in the major axis direction) is also larger than a length of the upper cover surface 211a. This is because the internal space of the upper housing 210 includes a space of the upper cover surface 211a in the forward/rearward direction and a space of the rear cover surface 211b in the forward/rearward direction.

Meanwhile, a height of a lower space of the rear cover surface 211b may be larger than a height of a lower space of the upper cover surface 211a. In addition, a height of a lower space of the lateral cover portion 212 may be larger than the height of the lower space of the upper cover surface 211a.

Meanwhile, the internal space of the upper housing 210 will be described below based on the state in which the printed circuit board 240 is disposed in the upper housing 210. When the printed circuit board 240 is accommodated in the upper housing 210, the upper cover portion 211 may cover an upper side of the printed circuit board 240. In this case, the printed circuit board 240 may be disposed to be spaced apart from the upper cover surface 211a at a predetermined interval. In this case, the interval may be very small to reduce the overall volume. However, in case that the interval between the printed circuit board 240 and the upper cover surface 211a is small as described above, heat generated from the printed circuit board 240 may accumulate on the printed circuit board 240 without circulating through convection.

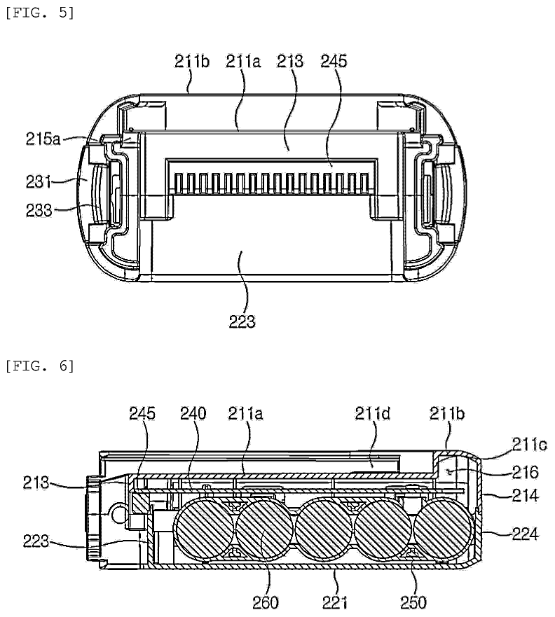

In order to solve this problem, in the battery 200 according to the embodiment of the present disclosure, a space with a predetermined height may be formed above a rear end and ends of two opposite surfaces of the printed circuit board 240. In this case, the space may provide a height difference larger than the interval between the printed circuit board 240 and the upper cover surface 211a. Therefore, the heat generated from the printed circuit board 240 may be dissipated to the space (hereinafter, referred to as a heat dissipation space 217), which may prevent the printed circuit board 240 from being overheated (see FIG. 6).

The lower housing 220 defines a lower external shape of the battery 200. The lower housing 220 is coupled to the upper housing 210 and defines a space in which the components including the printed circuit board 240 and the battery cell 260 may be accommodated.

The lower housing 220 may be formed in a shape similar to a box shape opened at an upper side thereof. Specifically, the lower housing 220 may include a lower cover portion 221, a pair of lateral cover portions 222 extending upward from two opposite sides of the lower cover portion 221 based on the major axis direction, a front cover portion 223 extending upward from a front end of the lower cover portion 221, and a rear cover portion 224 extending upward from a rear end of the lower cover portion 221.

The lower cover portion 221 may be formed in a flat plate shape, and the cell holder 250 and the battery cell 260 may be disposed on an upper surface of the lower cover portion 221. For example, the lower cover portion 221 may be formed in a rectangular flat plate shape, and the cell holder 250 is disposed on the upper surface of the lower cover portion 221, such that the lower cover portion 221 may support the battery cell 260 disposed in the cell holder 250.

The pair of lateral cover portions 222 may be symmetrically formed. For example, the pair of lateral cover portions 222 may extend upward from the lower cover portion 221 and each be formed in a curved shape having a predetermined curvature. That is, the lower cover portion 221 and the pair of lateral cover portions 222 may be connected in the form of a continuous surface. With this configuration, in case that an impact is applied to the battery 200, the impact may be prevented from being concentrated at a particular position on the battery 200, thereby improving durability.

The front cover portion 223 may be formed to cover a front side of the lower housing 220. The front cover portion 223 may cover a front side of the battery cell 260. For example, the front cover portion 223 may extend upward from the front end of the lower cover portion 221.

Meanwhile, the front cover portion 223 of the lower housing 220 may be disposed rearward of the front cover portion 213 of the upper housing 210. That is, the front cover portion 223 of the lower housing 220 and the front cover portion 213 of the upper housing 210 may not be disposed at positions that are in contact with each other. In other words, a level difference may be present between the front cover portion 223 of the lower housing 220 and the front cover portion 213 of the upper housing 210. This is to ensure that an upper side of the connector 245 is covered by the front cover portion 213, and a lower side of the connector 245 is exposed to the outside so as to be connected to the cleaner 100. That is, the connector 245 may be disposed below the upper housing 210 and disposed forward of the front cover portion 223 of the lower housing 220. Therefore, the connector 245 may be easily coupled to the main body 110, and dust or the like may be prevented from accumulating on the connector 245.

Meanwhile, a height at which the front cover portion 223 is formed in the upward/downward direction may be equal to a height at which the lateral cover portion 222 is formed in the upward/downward direction. However, the present disclosure is not limited thereto. A height difference may occur depending on the embodiments. In case that the height difference occurs, the printed circuit board 240 or at least a part of the connector 245 may pass through a space formed by the height difference.

Meanwhile, fixing portions 223a may be formed on the front cover portion 223. The fixing portion 223a may be disposed to protrude forward from the front cover portion 223, and a groove or hole may be formed in the protruding portion. The fixing portion 223a may fix the coupled state of the upper housing 210 and the lower housing 220 by means of a coupling member such as a screw.

The rear cover portion 224 and formed to cover a rear side of the lower housing 220. In this case, according to the embodiment, the rear end of the rear cover portion 221 and the rear cover portion 224 may be connected in the form of a continuous surface while defining a curved surface. Therefore, an impact may be prevented from being concentrated at a particular position when an external force is applied.

Meanwhile, the lower housing 220 further includes button coupling portions 225. The pair of lateral cover portions 222 may extend forward from the button coupling portions 225. At least a part of the button coupling portion 225 may further protrude forward than the front cover portion 223.

Further, the button parts 230 to be described below may be respectively coupled to the button coupling portions 225. Specifically, the button part 230 may be hingedly coupled to an outer side of the button coupling portion 225 (in the direction opposite to the direction in which the button coupling portions 225 face each other). For example, the button coupling portions 225 may each have a surface facing a bottom of the button part 230, and a hinge groove 225b coupled to be rotatable relative to a hinge protrusion of the button part 230.

Meanwhile, a spring may be disposed between the button part 230 and the button coupling portion 225. Specifically, an elastic member coupling portion 225c may be formed on the button coupling portion 225, and one end of an elastic member 235 may be in contact with and supported by the elastic member coupling portion 225c. For example, the elastic member coupling portion 225c may be formed in a circular flat shape, and at least one rib may protrude from an outer periphery of the elastic member coupling portion 225c and guide a coupling position of the elastic member 235.

Meanwhile, fastening portions 226 configured to be coupled to the upper housing 210 may be provided on the lower housing 220. For example, the fastening portions 226 may protrude from the inner surface of the lateral cover portion 222 and the inner surface of the rear cover portion 224 and extend upward to be higher than an upper end of the lateral cover portion 222 and an upper end of the rear cover portion 224. A groove or hole may be formed at a part of an upper side of the fastening portion 226 so that a hook may be caught by the groove or hole.

In this case, the plurality of fastening portions 226 may be formed at predetermined distances. For example, the pair of fastening portions 226 may be formed on each of the pair of lateral cover portions 222, and the pair of fastening portions 226 may be formed on the rear cover portion 224. Therefore, the coupling force may be maintained even though an external force is applied to the front or rear side of the battery 200, and the coupling force may be maintained even though an external force is applied to the left or right side of the battery 200.

With this configuration, when the upper housing 210 and the lower housing 220 are fitted with each other, the fastening portions 226 may be coupled to the fastening portions 216 of the upper housing 210 by a hook engagement.

Meanwhile, cell holder fixing portions 227 may be formed on the lower housing 220. The cell holder fixing portion 227 may be formed rearward of the front cover portion 223 and formed inside the lateral cover portion 222. In addition, when viewed from above, the cell holder fixing portion 227 may be disposed forward of a board body 241. The cell holder fixing portion 227 may be formed in a groove shape so that a coupling member such as a screw may be coupled to the cell holder fixing portion 227. Therefore, the cell holder 250 and the lower housing 220 may be fixed.

Therefore, an overall shape of the housing of the battery 200 made by coupling the upper housing 210 and the lower housing 220 may be a shape similar to a rectangular parallelepiped shape. In this case, the printed circuit board 240, the cell holder 250, and the battery cell 260 may be accommodated in the housing of the battery 200.

Meanwhile, the button coupling portions 215 of the upper housing 210 and the button coupling portions 225 of the lower housing 220 may be formed in shapes protruding forward from two opposite left and right sides of the housing of the battery 200 formed in a rectangular parallelepiped shape. Further, the button parts 230 may be coupled to the button coupling portions 215 and 225.

The button part 230 is a constituent element configured to fix the battery 200 to the battery coupling part 133 or separate the battery 200 from the battery coupling part 133. The button part 230 is disposed on the button coupling portions 215 and 225 and selectively fixes the housing of the battery 200 to the battery coupling part 133.

The button part 230 is disposed on the button coupling portions 215 and 225. According to the present disclosure, the button part 230 is released from the battery coupling part 133 while moving toward the inside of the housing of the battery 200.

In this case, an available space needs to be formed in the button part 230 so that a hook of the button part 230 may be moved. For this reason, in the related art, the button part 230 inevitably protrudes to the outside of the housing of the battery 200.

However, according to the present disclosure, the button part 230 is disposed on the button coupling portions 215 and 225, such that an outer end of the button part 230 may be disposed on the same surface as a lateral surface of the housing of the battery 200, and the shape of the battery 200 is more compact.

The button coupling portions 215 and 225 protrude forward. With this arrangement, an area in which the battery 200 and the battery coupling part 133 are in contact with each other is increased, such that the battery 200 may be more stably supported on the battery coupling part 133.

With this arrangement, the user may easily separate the battery 200 by pushing the button part 230 in a state in which the user grips the battery 200 with one hand.

In addition, the pair of button parts 230 is disposed at positions at which the pair of button parts 230 covers the two opposite sides of the connector 245 based on the leftward/rightward direction. Therefore, the button parts 230 and the button coupling portions 215 and 225 may protect the two opposite sides of the connector 245.

Therefore, based on the state in which the battery 200 is coupled to the main body 110, the left and right sides of the connector 245 are protected by the button parts 230 and the button coupling portions 215 and 225, and the upper side of the connector 245 is protected by the handle assembly 130, which may improve the durability related to the connection between the connector 245 and the main body 110.

The button part 230 may include a pressing portion 231, hinges 232, a hook 233, and stoppers 234.

The pressing portion 231 is a constituent element configured to operate the button part 230. The pressing portion 231 initiates the operation when the pressing portion 231 is pressed by an external force. The pressing portion 231 may rotate the button part 230 by being pressed by the user's finger.

The pressing portion 231 may be formed in a plate shape in which left and right surfaces are large, and front, rear, upper, and lower surfaces are small.

The pressing portion 231 may define a part of the external shape of the battery 200. Specifically, a groove may be formed in a part of the left or right surface of the housing of the battery 200, and the pressing portion 231 may be disposed in the groove and cover an outer side of the groove.

Meanwhile, the button part 230 may further include an elastic member holder 231a protruding from an inner surface of the pressing portion 231 and coupled to the elastic member 235. The elastic member holder 231a fixes a position of the elastic member 235.

The hinge 232 is a constituent element about which the button part 230 is rotated. The hinge 232 is disposed at a rear end of the pressing portion 231 and rotatably coupled to the housing of the battery 200.

The hinge 232 may extend from the pressing portion 231 in the upward/downward direction. For example, the hinges 232 may extend in the upward/downward direction from upper and lower surfaces of the rear end of the pressing portion 231.

The hinges 232 are rotatably coupled to hinge grooves 215b and 225b formed in the housing of the battery 200.

In this case, an imaginary extension line L1, which connects the pair of hinge grooves 215b and 225b, may be disposed rearward of the front cover portion 213 and 223. Therefore, even though the user's operating force is applied, the upper housing 210 and the lower housing 220 may support the operating force.

In addition, the imaginary extension line L1, which connects the pair of hinge grooves 215b and 225b, may be disposed forward of the front end of the cell holder 250. Therefore, it is possible to prevent an operating force, which is applied by the user to manipulate the button part 230, from being applied to the battery cell 260.

Therefore, the hinges 232 may provide a central axis about which the button part 230 may be rotated. Therefore, the button part 230 may be rotated about the hinges 232 relative to the left and right sides of the battery 200.

The hinge 232 is disposed outside the battery cell 260. The hinge 232 may be disposed forward of the battery cell 260 based on the forward/rearward direction. In addition, the hinge 232 may be disposed outside the battery cell 260 based on the leftward/rightward direction. In addition, based on the leftward/rightward direction, the hinges 232 may be disposed on the same line as the two opposite ends in the leftward/rightward direction of the cell holder 250 that surrounds the two opposite ends of the battery cell 260 based on the leftward/rightward direction.

With this arrangement, even though an impact is applied to the hinge 232 during a process in which the user pushes and manipulates the button part 230 or the button part 230 is fastened to the battery coupling part 133, it is possible to prevent the impact from being transmitted to the battery cell 260.

The hook 233 is a constituent element configured to fix the battery 200 to the battery coupling part 133. The hook 233 is disposed at a front end of the pressing portion 231 and configured to be caught by the battery coupling part 133.

The hook 233 protrudes forward from the front end of the pressing portion 231.

In this case, the hook 233 may be formed in a wedge shape and caught and fixed by a hook catching projection 1332 formed on the battery coupling part 133.

When the hook 233 is not operated, the hook 233 is disposed outside the battery cell 260 based on the leftward/rightward direction. When the pressing portion 231 is rotated by the user, the hook 233 is disposed inside the battery cell 260 based on the leftward/rightward direction. That is, with reference to FIG. 19, ends of the battery cells 260 based on the leftward/rightward direction are disposed on a pair of imaginary battery cell arrangement lines L2. In this case, a side between the pair of battery cell arrangement lines L2 may be referred to as the inside, and a direction away from the inside may be referred to as the outside. In a state in which the hook 233 is coupled to the coupling part 133 or the battery 200 is separated, at least a part of the hook 233 may be disposed outside extension lines of the pair of battery cell arrangement lines L2. Meanwhile, when the pressing portion 231 is pushed by the user, the hook 233 may be moved to the inside of the pair of battery cell arrangement lines L2.

With this arrangement, it is possible to ensure a minimum space in which the button part 230 needs to be moved to release the battery 200 from the battery coupling part 133, such that the space of the battery 200 may be efficiently used.

Meanwhile, assuming that the direction in which the battery 200 is coupled to the battery coupling part 133 is a first direction, the hinge 232 may be disposed on the same line as the battery cell 260 in a second direction intersecting the first direction or disposed outside the battery cell 260, and the hook 233 may be disposed outside the battery cell 260 in the first direction. As described above, the first direction is the forward direction, and the second direction is the lateral direction (leftward/rightward direction). That is, the hinge 232 may be disposed on the line L2 or disposed outside the line L2. The hook 233 is disposed forward of the front end of the battery cell 260. With this arrangement, the hook 233 may be disposed outside the battery cell 260 in case that the hook 233 is coupled to the coupling part 133 or the battery 200 is separated. In case that the pressing portion 231 is pushed by the user, the hook 233 may be moved to the space formed forward of the battery cell 260 (the space formed at the front ends of the button coupling portions 215 and 225).

This is to support the battery cell 260 and disperse the impact by aligning the coupling positions of the hook 233 and the battery coupling part 133, the hinges 232, and left and right ends of the cell holder 250.

That is, according to the present disclosure, the hook 233, the hinge 232, and the left and right ends of the cell holder 250 are concentratively disposed between the battery cell arrangement line L2 and the lateral cover portion 212, which may protect the left and right side ends of the battery cell 260. In addition, the lateral cover portion 212, the cell holder 250, the button part 230, and the battery coupling part 133 are connected to one another in the forward/rearward direction, such that even though an impact is applied to the battery 200, the impact is not concentrated on any one point, and the impact may be mitigated by being dispersed in the forward/rearward direction.

Therefore, according to the present disclosure, it is possible to protect the battery cell 260 from an external impact.

Meanwhile, the stopper 234 may extend from the pressing portion 231 and restrict a movement range of the button part 230 by coming into contact with the button coupling portion 225.

The stopper 234 may extend from the pressing portion 231 in the upward/downward direction. For example, the stopper 234 may be disposed between the hinge 232 and the hook 233 based on the forward/rearward direction. In addition, the stopper 234 may be disposed forward of the elastic member holder 231a.

The stopper 234 may be disposed so that an outer surface of the stopper 234 (in the direction toward the outside of the battery 200) faces catching projections 215d and 225d of the button coupling portion 225. Therefore, even though the button part 230 is pushed to the outside of the battery 200 by an elastic force of the elastic member 235, the stopper 234 may be supported by coming into contact with the catching projections 215d and 225d.

Meanwhile, the battery 200 further includes the elastic member 235.

The elastic member 235 may return the button part 230 to an original position by applying a restoring force when the button part 230 moves. For example, the elastic member 235 may be a coil spring.

One end of the elastic member 235 may be coupled to the elastic member coupling portion 225c formed on the button coupling portion 225. In addition, the other end of the elastic member 235 may be coupled to the elastic member holder 231a of the button part 230. In this case, the elastic member holder 231a may be disposed between the hook 233 and the hinge 232.

With this configuration, the elastic member 235 may be supported by the button coupling portion 225. When the button part 230 rotates, the elastic member 235 may apply the restoring force to the button part 230.

Meanwhile, in the case of a printed circuit board in the related art, only a circuit for controlling the charging and discharging of a battery is mounted in the battery, and a circuit for controlling a suction motor is mounted on a separate printed circuit board and provided in the main body of the cleaner.

In this case, the printed circuit board in the main body of the cleaner may block a flow of air, which may degrade efficiency in sucking dust or cause discomfort in which the volume of the main body of the cleaner is increased.

In order to solve the problem, in the present disclosure, the printed circuit board, on which elements including an inverter element are mounted together not only to control the charging and discharging of the battery but also to control the suction motor, is disposed in the battery 200, which may simplify the internal structure of the main body 110 of the cleaner.

That is, according to the embodiment of the present disclosure, the battery 200 includes the printed circuit board 240. An element for controlling the battery 200 and an element for controlling the main body 110 may be mounted on the printed circuit board 240. Specifically, the printed circuit board 240 according to the embodiment of the present disclosure may be mounted with circuit elements connected to the battery cell 260 and configured to control the charging and discharging of the battery cell 260, and circuit elements connected to the cleaner 100 and configured to operate the suction motor (not illustrated). For example, the printed circuit board 240 may be mounted with heating elements, such as switching elements of an inverter, which is connected to a power line, and DC resistor elements. In addition, the printed circuit board 240 may also be mounted with elements such as an MCU, a gate driver, an SMPS, and an LDO.

The printed circuit board 240 includes the board body 241, a connector connection portion 242, a board extension portion 243, and guide holes 244.

The board body 241, the connector connection portion 242, and the board extension portion 243 may be an integrated board.

In this case, the board body 241 may be a board formed in a rectangular shape and occupy most of the area of the printed circuit board 240. For example, the board body 241 may occupy 70% or more of the area of the printed circuit board 240.

Meanwhile, at least a part of the board body 241 may be disposed to face the upper cover surface 211a. In this case, a width W2 of the board body 241 in the leftward/rightward direction may be equal to or larger than 0.8 times a width between the pair of lateral cover portions 222. This is because not only the circuit for controlling the battery 200, but also the circuit for controlling the main body 110 is mounted.

Meanwhile, the width W2 of the board body 241 in the leftward/rightward direction is smaller than a width of the upper housing 210 or the lower housing in the leftward/rightward direction or a width W1 of the cell holder 250 in the leftward/rightward direction (W2<W1). In this case, when viewed from above, the two opposite ends of the battery cell 260 based on the leftward/rightward direction may be further exposed outward in the leftward/rightward direction than the board body 241.

In this case, a shortest distance from an upper end of the cell holder 250 to an upper end of the lateral cover portion 212 may be longer than a shortest distance from the upper end of the cell holder 250 to the upper cover surface 211a, and the board body 241 may be disposed between the cell holder 250 and the upper cover surface 211a.

In addition, the upper end of the lateral cover portion 212 may be disposed to be higher than the upper cover surface 211a, and an electrode of the battery cell 260 may be disposed vertically below the lateral cover portion 212.

With this configuration, a space may be formed between the two opposite ends of the board body 241 based on the leftward/rightward direction and the lateral cover portions 212 and 222. In addition, it is possible to prevent the board body 241 from completely covering the upper side of the cell holder 250 and form the space in which air may flow.

As a result, it is possible to prevent a situation in which heat discharged from the heating elements mounted on the board body 241 is concentratively transferred to the battery cell 260 and degrades the performance of the battery cell 260. In addition, it is possible to prevent a situation in which heat discharged from the battery cell 260 is continuously transferred to the printed circuit board 240 and damages the printed circuit board 240.

Meanwhile, in the present disclosure, a space, which corresponds to a height difference between the upper cover surface 211a and the coupling guide portion 211d, is formed above the space formed between the two opposite ends of the board body 241 based on the leftward/rightward direction and the lateral cover portions 212 and 222. The space provides a space higher than the space between the board body 241 and the upper cover surface 211a. In addition, the space is formed to also communicate with the heat dissipation space 217.

Therefore, it is possible to provide the space, in which the heat generated from the printed circuit board 240 and the battery cell 260 may flow, and to prevent a situation in which the heat is concentrated at a particular point and damages the battery cell 260 or the printed circuit board 240.

Meanwhile, the connector connection portion 242 extends from the board body 241 and is coupled to the connector 245. Specifically, the connector connection portion 242 may extend forward from the front end of the board body 241.

Meanwhile, a width W3 of the connector connection portion 242 in the leftward/rightward direction may be smaller than the width W2 of the board body 241 in the leftward/rightward direction (W3<W2). That is, the width W3 of the connector connection portion 242 in the leftward/rightward direction is smaller than 100% of the width W2 of the board body 241 in the leftward/rightward direction.

Therefore, a cross-sectional area occupied by the connector 245 may be smaller than a cross-sectional area of the portion that accommodates the battery cell 260, and the button part 230 may be disposed in the reduced space, which may reduce an overall volume of the battery 200.

Meanwhile, in the case of the printed circuit board, on which elements including the inverter element are mounted together not only to control the charging and discharging of the battery but also to control the suction motor, the circuit connected to the suction motor needs to be connected to the connector. Therefore, the circuits, which are twice or more in number than the circuits for controlling the battery, may be mounted on the printed circuit board.

In this case, because the plurality of circuits is collected on the single printed circuit board 240, the battery 200, which accommodates the plurality of circuits, may increase in size, or the point, at which the connector 245 and the main body 110 are connected, may be vulnerable to impact.

Therefore, in the battery 200 according to the embodiment of the present disclosure, the width W3 of the connector connection portion 242 in the leftward/rightward direction is 50% or more of the width W2 of the board body 241 in the leftward/rightward direction. In case that the width W3 of the connector connection portion 242 in the leftward/rightward direction is smaller than 50% of the width W2 of the board body 241 in the leftward/rightward direction, the width of the board is too small, which makes it difficult to connect all the circuits for charging and discharging the battery and the circuits for controlling the suction motor to the connector 245. Even though the connection is possible, there is a limitation in that the connection is vulnerable to an external impact.

Therefore, in the present disclosure, the width of the connector connection portion 242 is set to be comparatively large, such that the connector 245 and the circuits mounted on the printed circuit board 240 are stably connected, and the durability between the connector 245 and the main body 110 is improved, which may stably maintain the performance of the cleaner 100.

Meanwhile, the cell holder fixing portion 227 may be disposed outside the connector connection portion 242 based on the leftward/rightward direction. That is, the connector connection portion 242 may be disposed between the pair of cell holder fixing portions 227. In addition, the cell holder fixing portion 227 may be disposed rearward of the front cover portion 223 of the lower housing 220 and disposed forward of the board body 241.

Therefore, the cell holder 250 may be stably fixed in the lower housing 220. Further, when the cell holder fixing portion 227 and the cell holder 250 are fixed by a coupling member such as a screw, the durability of the region between the pair of cell holder fixing portions 227 against an external impact may be improved. Therefore, the connector connection portion 242 disposed between the pair of cell holder fixing portions 227 may also be protected.

In addition, when the upper housing 210 and the lower housing 220 are separated, the cell holder fixing portion 227 is exposed when viewed from above the printed circuit board 240, such that a work tool, such as a screwdriver, may easily enter the cell holder fixing portion 227 during the process of assembling or disassembling the battery 200.

Meanwhile, the board extension portion 243 extends from the board body 241. Specifically, the board extension portion 243 may extend rearward from the rear end of the board body 241. In this case, at least a part of the board extension portion 243 may be disposed to face the rear cover surface 211b.

Meanwhile, the width of the board extension portion 243 in the leftward/rightward direction may be smaller than the width W2 of the board body 241 in the leftward/rightward direction. That is, the width of the board extension portion 243 in the leftward/rightward direction is smaller than 100% of the width W2 of the board body 241 in the leftward/rightward direction.

In the present disclosure, the board extension portion 243 is asymmetrically formed on the printed circuit board 240. For example, the board extension portion 243 may be formed as only a part of the right side of the rear end of the board body 241 extends rearward. As another example, the board extension portion 243 may be formed as only a part of the left side of the rear end of the board body 241 extends rearward. That is, the printed circuit board 240 may be formed in an asymmetric plate shape as a whole.

In this case, a width of the board extension portion 243 in the leftward/rightward direction may be equal to or smaller than half the width W2 of the board body 241 in the leftward/rightward direction.

Therefore, the two opposite ends of the board extension portion 243 based on the width direction may have different shortest distances to the pair of lateral cover portions 212.

Therefore, in case that the convection of air occurs in accordance with heat generation in the internal space of the battery 200, the air uniformly may flow upward without stagnating, and vortices may occur. Therefore, the heated air may be maximally mixed while thermally circulating in the internal space of the battery 200, which may prevent heat from being concentrated at a particular position.

Meanwhile, a space may be formed between a rear end of the board extension portion 243 and the rear cover portions 214 and 224. In addition, a space may be formed between a rear end of the board body 241 and the rear cover portions 214 and 224. In this case, a larger space may be formed in a region in which the board extension portion 243 is not present at the rear end of the board body 241.

Therefore, it is possible to prevent the printed circuit board 240 from completely covering the upper side of the cell holder 250 and form the space in which air may flow.

As a result, it is possible to prevent a situation in which heat discharged from the heating elements mounted on the printed circuit board 240 is concentratively transferred to the battery cell 260 and degrades the performance of the battery cell 260. In addition, it is possible to prevent a situation in which heat discharged from the battery cell 260 is continuously transferred to the printed circuit board 240 and damages the printed circuit board 240.

Meanwhile, in the present disclosure, the heat dissipation space 217 is formed above the space formed between the rear end of the printed circuit board 240 and the rear cover portions 214 and 224. That is, a shortest distance from the board extension portion 243 to the rear cover surface 211b may be longer than a shortest distance from the board body 241 to the upper cover surface 211a. Further, the space, which corresponds to the distance difference, may define the heat dissipation space 217.

Therefore, it is possible to provide the space, in which the heat generated from the printed circuit board 240 and the battery cell 260 may flow, and to prevent a situation in which the heat is concentrated at a particular point and damages the battery cell 260 or the printed circuit board 240.

Meanwhile, the guide hole 244 may be provided as a plurality of guide holes 244 formed in the board body 241 and guide the coupling positions of the cell holder 250 and the printed circuit board 240.

For example, four guide holes 244 may be formed in the board body 241, guide pins 252 to be described below may pass through two guide holes 244a, and coupling members, such as screws, may pass through the remaining two guide holes 244b. In this case, in case that four guide holes 244 are formed at vertices of a quadrangle, the pair of guide holes 244a, through which the guide pins 252 pass, and the pair of guide holes 244b, through which the coupling members pass, may be disposed on diagonal lines.

With this configuration, a sufficient fixing force may be provided in the forward/rearward direction and the leftward/rightward direction with a minimum number of assembling processes.

Meanwhile, the battery 200 of the present disclosure further includes the connector 245 connected to the main body 110 in an electrical and circuit manner.

The connector 245 is coupled and connected to the printed circuit board 240 in an electrical and circuit manner. Specifically, the connector 245 may be coupled to the connector connection portion 242 and connected to the circuit mounted on the connector connection portion 242.

The connector 245 may be detachably coupled to the main body 110. When the connector 245 is coupled to the main body 110, the connector 245 may transmit power and electrical signals to the main body 110. Specifically, at least one terminal (pin) may be provided on the connector 245. When the battery 200 is coupled to the battery coupling part 133, the terminal (pin) may be connected to a terminal (pin) provided on the battery coupling part 133.

Meanwhile, the connector 245 may be coupled to the lower side of the printed circuit board 240. Therefore, the printed circuit board 240 and the upper housing 210 may cover the upper side of the connector 245, such that it is possible to prevent dust from accumulating on the connector 245 even in case that the battery 200 is separated from the main body 110 and stored separately. Therefore, it is possible to reduce connection errors of the connector 245.

In addition, the fixing portions 213b and 223a may be disposed at the two opposite sides of the connector 245 based on the leftward/rightward direction and fix the upper housing 210 and the lower housing 220. In this case, according to the embodiment, grooves may be formed in the fixing portions 213b and 223a, and at least a part of the connector 245 may be accommodated in the grooves.

Therefore, during the process of assembling the upper housing 210 and the lower housing 220, a high fixing force may be applied to the fixing portions 213b and 223a, and a high fixing force may be maintained between the printed circuit board 240 and the connector 245.

Meanwhile, the cell holder 250 is disposed in the internal space of the battery 200, which is defined by coupling the upper housing 210 and the lower housing 220, and the cell holder 250 is provided to surround at least a part of the battery cell 260.

The cell holder 250 includes a holder body 251, the guide pins 252, board fixing portions 253, holder fixing portions 254, an organization hole 255, power connection holes 256, and heat dissipation holes 257.

The holder body 251 is formed to surround at least a part of the battery cell 260. The holder body 251 has a shape that defines an internal space in the leftward/rightward direction. For example, the holder body 251 may be formed to have a cylindrical internal space in the leftward/rightward direction. As another example, the holder body 251 may be formed to have an internal space capable of accommodating a rectangular parallelepiped shape in the leftward/rightward direction.

Therefore, the holder body 251 may be formed to have an internal space corresponding to the shape of the battery cell 260 and surround and protect the battery cell 260.

Meanwhile, the holder body 251 may be formed so that the plurality of battery cells 260 is disposed in parallel with one another. In this case, the configuration in which the plurality of battery cells 260 is disposed in parallel with one another means that the longitudinal directions of the plurality of battery cells 260 are disposed in parallel with one another based on the longitudinal direction (major axis direction) of the battery cell 260. For example, the holder body 251 may be formed so that five or six battery cells 260 are disposed in parallel with one another.

Meanwhile, the entire holder body 251 may be integrated, or the holder body 251 may include two components that are manufactured and then coupled to each other. In case that the holder body 251 includes two components, the components of the holder body 251 are fitted with the two opposite sides of the battery cell 260 based on the longitudinal direction, and the components are assembled by being coupled, such that the holder body 251 may be easily assembled.

Meanwhile, the holder body 251 may be disposed above the lower cover portion 221 and disposed below the printed circuit board 240. In this case, a plurality of ribs 258 protrudes from the lower surface of the holder body 251 (the surface disposed at a position facing the lower cover portion 221).

Therefore, a space may be formed between the battery cell 260 and the lower cover portion 221. Therefore, it is possible to prevent the battery cell 260 from coming into contact with the lower cover portion 221. Therefore, it is possible to prevent a situation in which the lower housing 220 is damaged by heat from the battery cell 260 or the heat is transferred to the user.

Meanwhile, an end 259 of the lower surface of the holder body 251 based on the leftward/rightward direction may have a cut-out shape. Therefore, some of the electrodes disposed at the end of the battery cell 260 based on the leftward/rightward direction may be exposed to the outside of the cell holder 250, which may effectively dissipate heat generated from the electrodes.

The guide pin 252 protrudes and extends upward from the holder body 251. Specifically, the guide pin 252 protrudes and extends from a surface of the holder body 251 that faces the printed circuit board 240. For example, a plurality of ribs may protrude radially outward from a cylindrical central portion of the guide pin 252 (see FIG. 20).

In this case, a maximum diameter of the guide pin 252 including the ribs may be larger than a diameter of the guide hole 244, and a diameter of the upper end of the guide pin 252 may be smaller than a diameter of the guide hole 244. Therefore, the ribs of the guide pin 252 may maintain the interval between the cell holder 250 and the printed circuit board 240 and prevent the printed circuit board 240 from being sagged downward by gravity.

Meanwhile, a plurality of guide pins 252 may be provided. For example, two guide pins 252 may be provided.

The board fixing portion 253 extends upward from the holder body 251. Specifically, the board fixing portion 253 extends from a surface of the holder body 251 that faces the printed circuit board 240. For example, the board fixing portion 253 may be formed in a cylindrical shape and have a groove or hole to which a fixing member, such as a screw or a nail, is coupled.

Meanwhile, a plurality of board fixing portions 253 may be provided. For example, two board fixing portions 254 may be provided.

Meanwhile, the pair of guide pins 252 and the pair of board fixing portions 253 may be disposed at diagonal positions. Therefore, a sufficient fixing force may be provided in the forward/rearward direction and the leftward/rightward direction with a minimum number of assembling processes.

The organization hole 255 is formed at a position on the holder body 251 that faces the printed circuit board 240. Some of the components provided on the printed circuit board 240 may be accommodated through the organization hole 255.

The power connection holes 256 are respectively formed in end surfaces of the holder body 251 based on the leftward/rightward direction and expose the electrodes of the battery cell 260.

In this case, the power connection hole 256 may be formed as one hole formed independently at two opposite ends of the holder body 251 based on the leftward/rightward direction that surrounds the corresponding battery cell 260 while corresponding to one battery cell 260. On the contrary, the power connection hole 256 may be formed as a long hole shape formed in the forward/rearward direction so as to connect the electrodes of the two adjacent battery cells 260 (see FIG. 20).

Therefore, the terminal connected to the printed circuit board 240 may be electrically connected to the electrode of the battery cell 260.

The heat dissipation hole 257 may be formed in an outer peripheral surface of the holder body 251 based on the upward/downward direction. In this case, a width of the heat dissipation hole 257 in the leftward/rightward direction may be equal to or larger than half a width of the holder body 251 in the leftward/rightward direction. Alternatively, in the printed circuit board 240, when the battery cell 260 is viewed, an area of the heat dissipation hole 257 may be equal to or larger than half an area of the upper side of the holder body 251.

Therefore, it is possible to discharge heat, which is generated from the battery cell 260, to the outside as much as possible.

The battery cell 260 is coupled to the cell holder 250, accommodated in the housing of the battery 200, and configured to supply power to the cleaner 100. A plurality of battery cells 260 may be provided. In this case, the plurality of battery cells 260 may be connected to one another in series or in parallel, and the serial connection and the parallel connection may be switched.

Hereinafter, a process of coupling the battery 200 according to the embodiment of the present disclosure to the main body 110 will be described below with reference to FIGS. 1 and 2.

In the present disclosure, the user may couple the battery 200 to the battery coupling part 133 by gripping the battery 200 and pushing the battery 200 from the rear side to the front side of the battery coupling part 133. In this case, the user may couple the battery 200 to the battery coupling part 133 by fitting the guide rail 1331, which is formed on the battery coupling part 133, with the coupling guide portion 211d of the upper housing 210 and pushing the battery 200 forward.

In this case, the hook 233 of the button part 230 may be rotated while being inserted along the inclined surface formed on the hook catching projection 1332, and the elastic member 235 may be compressed. Thereafter, when the hook 233 passes through the inclined surface of the hook catching projection 1332, the hook 233 is rotated to the original position by the restoring force of the elastic member 235 and caught by the hook catching projection 1332. Therefore, the battery 200 is coupled to the battery coupling part 133 (see FIG. 15).

Further, the lower rear end of the handle 131 (the rear end of the battery coupling part 133) is also supported while coming into contact with the stopper wall 211c. Further, the connector 245 is connected to the terminal (not illustrated) provided on the battery coupling part 133. Therefore, the battery 200 is connected to the main body 110 in physical, electrical, and signal manners.

Meanwhile, in the state in which the battery 200 is coupled to the main body 110, the user may separate the battery 200 from the battery coupling part 133 by gripping the battery 200 and pulling the battery 200 rearward. In a state in which the user grips the main body 110 with one hand, the user may manipulate the battery 200 with the other hand, thereby separating the battery 200 from the main body 110.

Specifically, in a state in which the user grips the handle 131 with one hand and surrounds the lower housing 220 with the palm of the other hand, the user may push the pair of pressing portions 231 with the thumb and the index finger or the thumb and the middle finger. When the pressing portion 231 is pushed, the hook 233 is rotated about the hinge 232 and moved toward the inside of the button coupling portions 215 and 225, such that the hook 233 is released from the hook catching projection 1332 (see FIG. 16). Thereafter, the user may separate the battery 200 from the main body 110 by pulling the battery 200 rearward in the state in which the pressing portion 231 is pushed.

According to the present disclosure battery for a cleaner described above, the user may easily separate the battery by pushing the button part with the finger in the state in which the user grips the battery.

In addition, the hinge and the hook of the button part are disposed in the housing of the battery, which may implement a compact shape.

In addition, the heat dissipation space and the flow path are formed to allow air to flow even in the compact space, which may minimize the amount of heat generated from the battery or the printed circuit board.

In addition, the work tool may easily approach the constituent components, such that the constituent components may be easily assembled.

While the present disclosure has been described with reference to the specific embodiments, the specific embodiments are only for specifically explaining the present disclosure, and the present disclosure is not limited to the specific embodiments. It is apparent that the present disclosure may be modified or altered by those skilled in the art without departing from the technical spirit of the present disclosure.

All the simple modifications or alterations to the present disclosure fall within the scope of the present disclosure, and the specific protection scope of the present disclosure will be defined by the appended claims.

### DESCRIPTION OF REFERENCE NUMERALS

100: Cleaner
110: Main body
120: Dust bin
130: Handle assembly
131: Handle
133: Battery coupling part
1331: Guide rail
1332: Hook catching projection
200: Battery
210: Upper housing
211d: Coupling guide portion
215: Button coupling portion
217: Heat dissipation space
220: Lower housing
225: Button coupling portion
230: Button part
231: Pressing portion
232: Hinge
233: Hook
234: Stopper
240: Printed circuit board
242: Connector connection portion
243: Rear extension portion
245: Connector
250: Cell holder
260: Battery cell

What is claimed is:

1. A battery for a cleaner, the battery comprising:
an upper housing;
a lower housing coupled to the upper housing and configured to define a space in which a battery cell and a printed circuit board are accommodated; and
a connector coupled to the printed circuit board and having a terminal,
wherein the printed circuit board comprises:
a board body; and
a connector connection portion extending from one end of the board body based on a longitudinal direction and coupled to the connector, and
wherein a width of the connector connection portion is equal to or larger than half a width of the board body.

2. The battery of claim 1, wherein the upper housing further comprises a pair of fixing portions configured to fix coupling of the upper housing and the lower housing, and
wherein the connector connection portion is disposed between the pair of fixing portions.

3. The battery of claim 1, wherein the lower housing further comprises a pair of fixing portions configured to fix coupling of the upper housing and the lower housing, and
wherein the connector is disposed between the pair of fixing portions.

4. The battery of claim 1, further comprising:
a cell holder configured to surround the battery cell,
wherein the lower housing comprises a pair of cell holder fixing portions configured to fix the cell holder, and
wherein the connector connection portion is disposed between the pair of cell holder fixing portions when viewed from above the printed circuit board.

5. The battery of claim 1, further comprising:
a cell holder configured to surround the battery cell,
wherein the lower housing comprises a pair of cell holder fixing portions configured to fix the cell holder, and
wherein the cell holder fixing portion is disposed forward of the board body when viewed from above the printed circuit board.

6. The battery of claim 1, further comprising:
a cell holder configured to surround the battery cell,
wherein the lower housing comprises a front cover portion configured to cover a front side of the cell holder, and
wherein the connector is disposed below the upper housing and disposed forward of the front cover portion.

7. The battery of claim 1, wherein the upper housing comprises:
an upper cover portion configured to cover an upper side of the printed circuit board; and
a pair of lateral cover portions extending downward from two opposite ends of the upper cover portion, and
wherein a width of the board body is equal to or larger than 0.8 times a width between the pair of lateral cover portions.

8. The battery of claim 1, wherein a circuit configured to control the battery and a circuit configured to control a main body of a cleaner are mounted together on the printed circuit board.

9. A cleaner comprising:
a main body configured to suck dust; and
a battery detachably coupled to the main body and configured to supply power to the main body,
wherein the battery comprises:
a printed circuit board; and
a connector connected to the printed circuit board and coupled to the main body in electrical and signal manners, and
wherein a width of the connector is equal to or larger than half a maximum width of the printed circuit board.

10. The cleaner of claim 9, wherein an inverter circuit configured to control the main body is mounted on the printed circuit board.
